(19) United States
(12) Patent Application Publication
(10) Pub. No.: US 2012/0309505 A1
(43) Pub. Date: Dec. 6, 2012

(54) ADVERTISEMENT GAME

(76) Inventor: John Hanlon, Condordville, PA (US)

(21) Appl. No.: 13/485,091

(22) Filed: May 31, 2012

Related U.S. Application Data
(60) Provisional application No. 61/491,881, filed on May 31, 2011.

(51) Int. Cl. A63F 13/00

(52) U.S. Cl. 463/25

(57) ABSTRACT

A game and a method of playing a game for more than one player where at least one segment of an advertisement is played simultaneously to each of the players and where the advertisement segment advertises at least does not immediately identify anything being advertised. The winning segment player for each segment is the player who is the first player to identify at least one of the advertised things in the advertisement without seeing or hearing in the segment anything being advertised. The game can be televised. The game can include assigning a fixed value, which can include, but is not limited to, money or points, to each passing second, fraction thereof or multiple thereof.

### PRIORITY CLAIM, CROSS REFERENCE TO RELATED APPLICATIONS AND INCORPORATION BY REFERENCE

This application is related to, claims priority under and claims the benefit of the earliest available effective filing dates from the following listed applications: Provisional application of John Hanlon, Ser. No. 61/491,881, filed on May 31, 2011, entitled: Advertisement Game Show. The entire disclosure of Provisional application of John Hanlon, Ser. No. 61/491,881, filed on May 31, 2011, entitled: Advertisement Game Show, is incorporated herein by reference.

### FIELD OF THE INVENTION

The invention includes but is not limited to games, game shows and advertisements.

### SUMMARY OF THE INVENTION

Embodiments of the method of playing the game and the game of the current invention includes providing more than one player, and playing at least one segment of an advertisement simultaneously to each of the players, where the advertisement segment advertises at least one thing but where the advertisement segment at least does not immediately identifying any of the at least one advertised things. The winning segment player for each segment is the player who is the first player to identify at least one of the advertised things in the advertisement without seeing or hearing in the segment any of the advertised things.

Embodiments of the game can be televised.

Embodiments of the game can include assigning a fixed value, which can include, but is not limited to, money or points, to each passing second, fraction thereof or multiple thereof. The winner of the segment can be awarded the money or point amount that accumulated from the passing second count until the winner correctly identified at least one advertised thing.

The game further can include embodiments providing a bonus to the segment round winner.

Embodiments of the game can include, but are not limited to, at least one segment of a commercial, at least one device to stop the segment, at least one display of at least one commercial segment, and at least one timer.

### BRIEF DESCRIPTION OF THE DRAWINGS

The accompanying drawings, which are incorporated in and form a part of the specification, illustrate the embodiments of the present invention and, together with the description, serve to explain the principles of the invention.

FIGS. 1-26 are flow charts of embodiments of the method of the game of the invention.

FIGS. 27 and 28 are dioramas of embodiments of the game of the invention.

### DETAILED DESCRIPTION OF EMBODIMENTS OF THE INVENTION

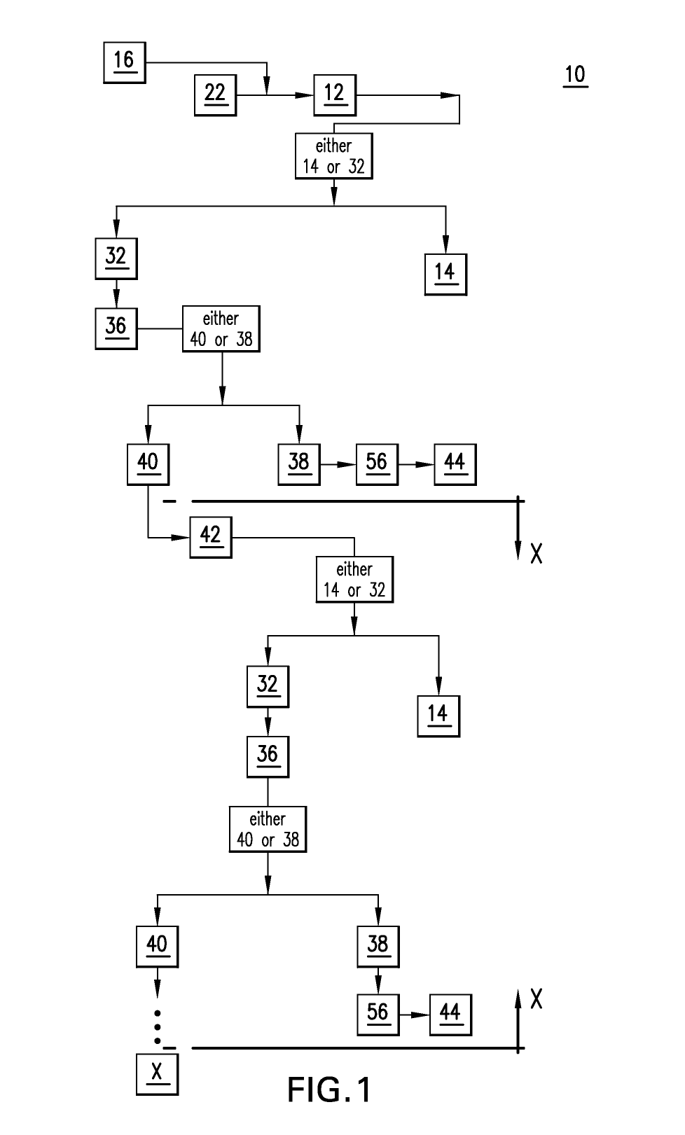

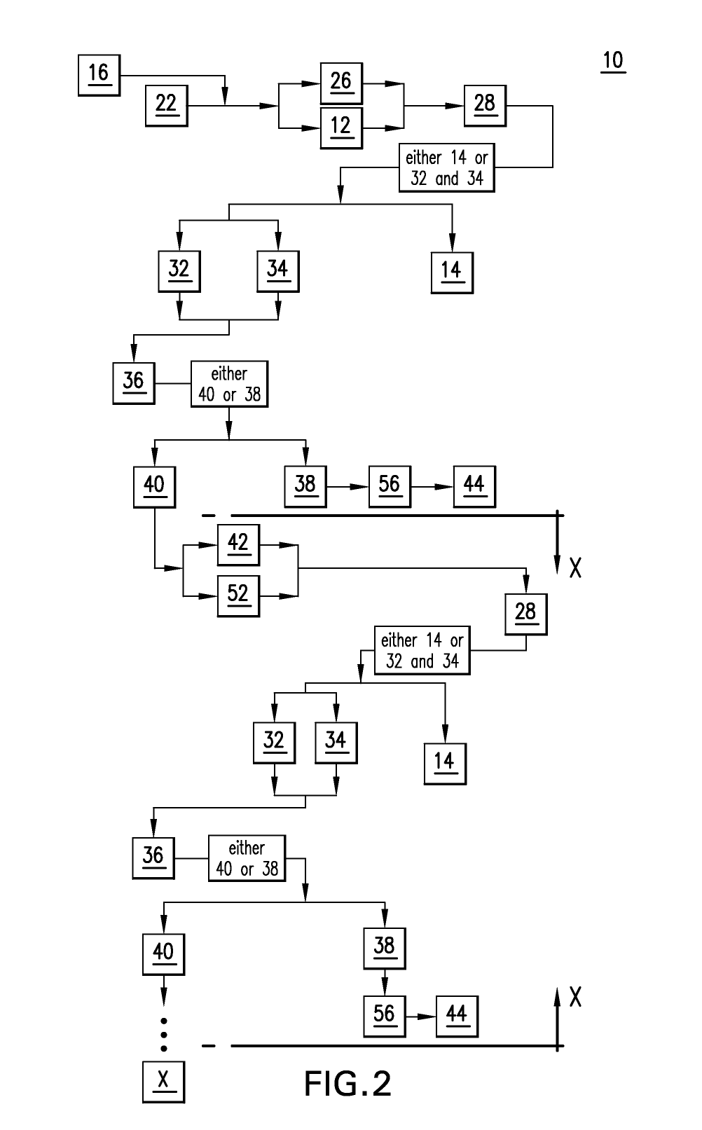

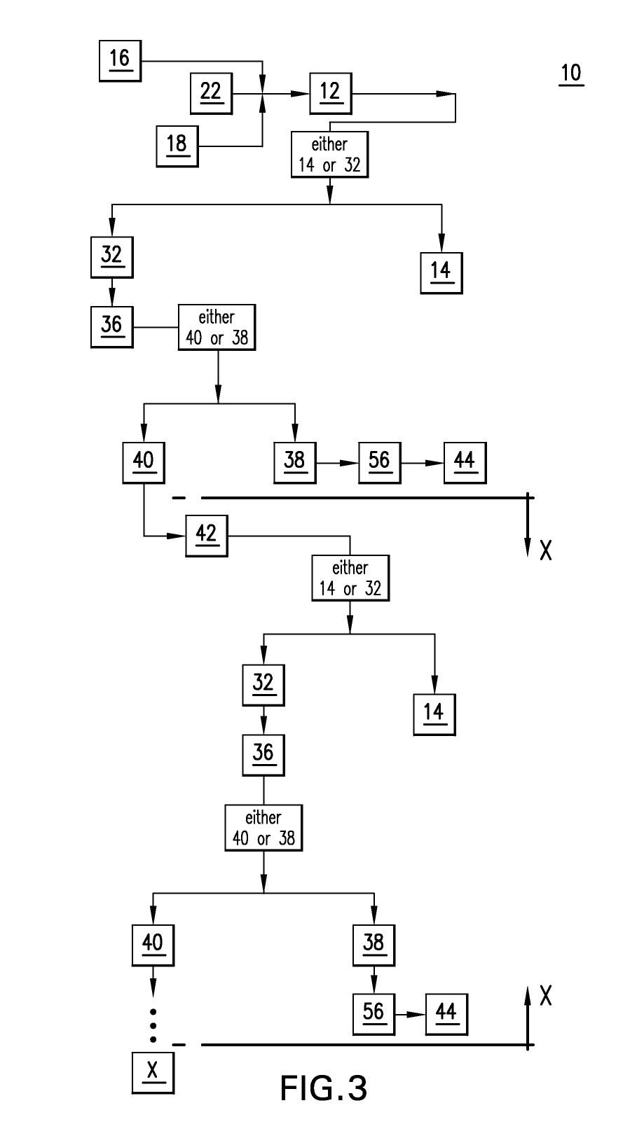

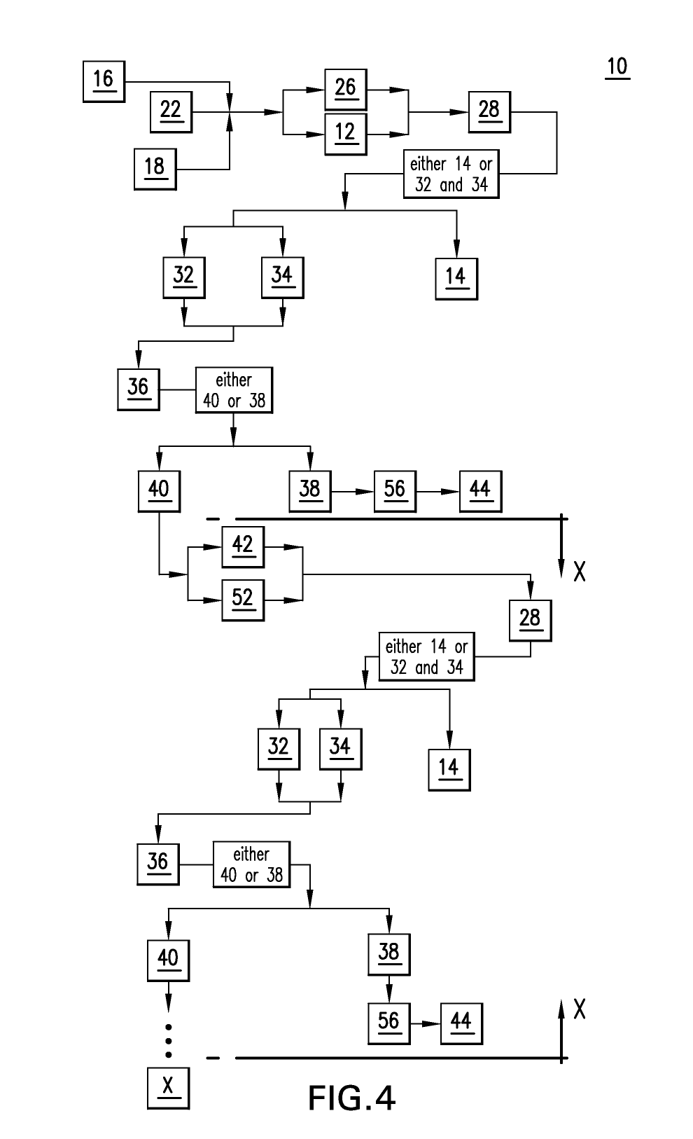

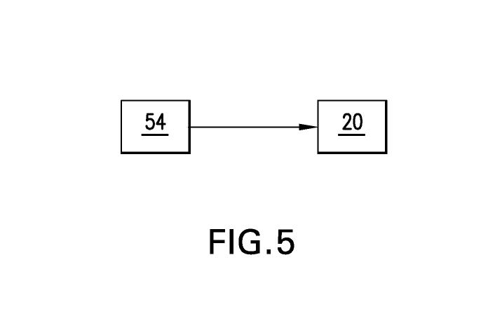

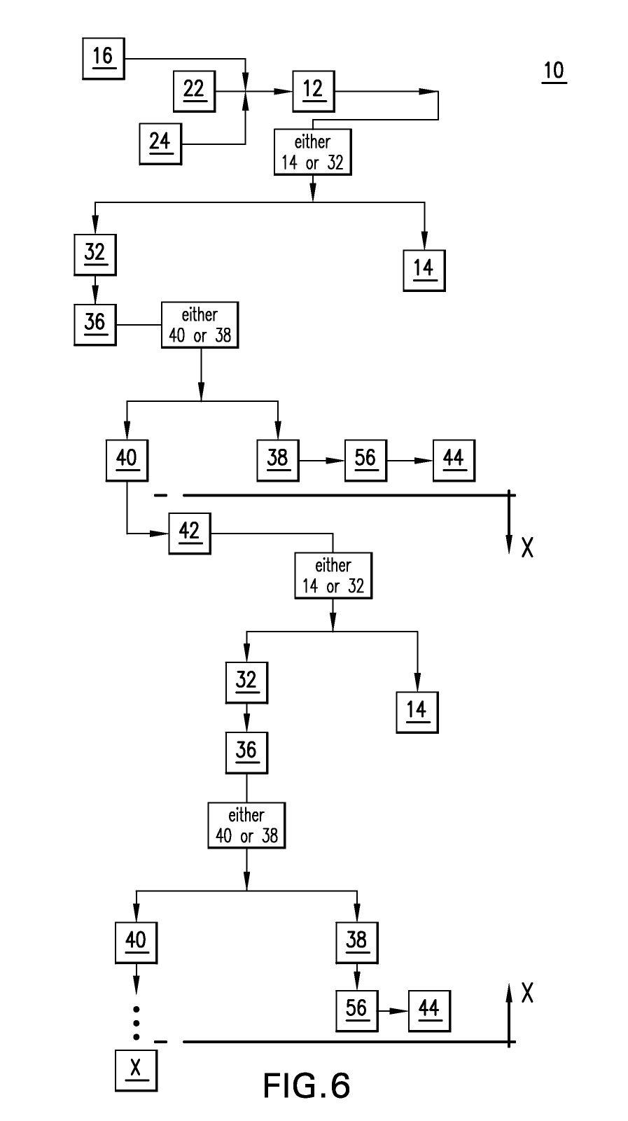

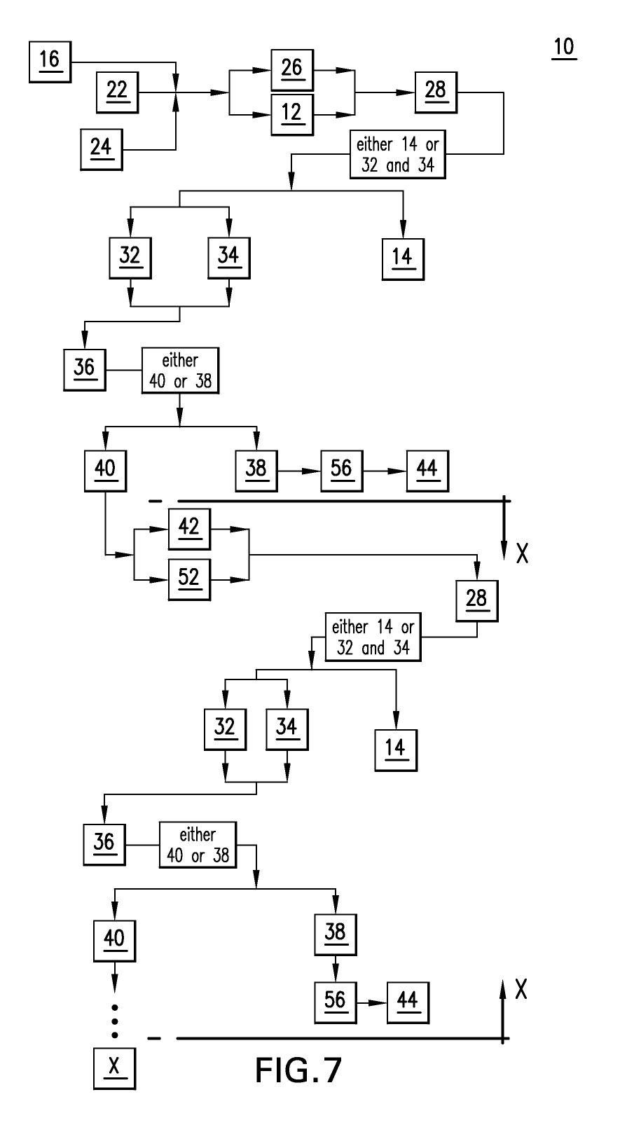

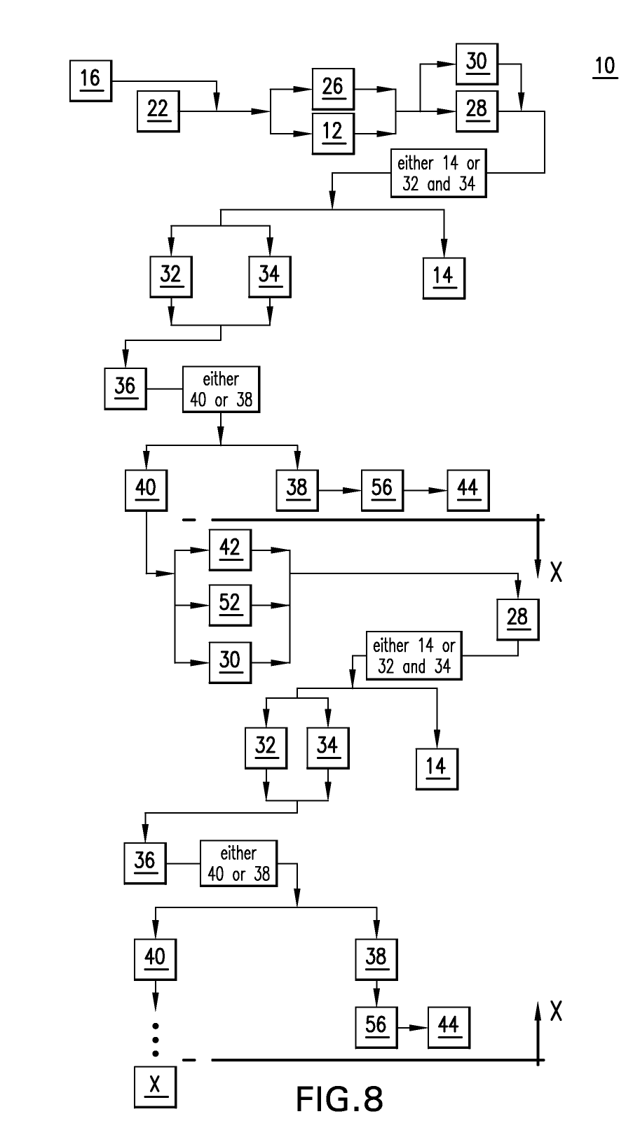

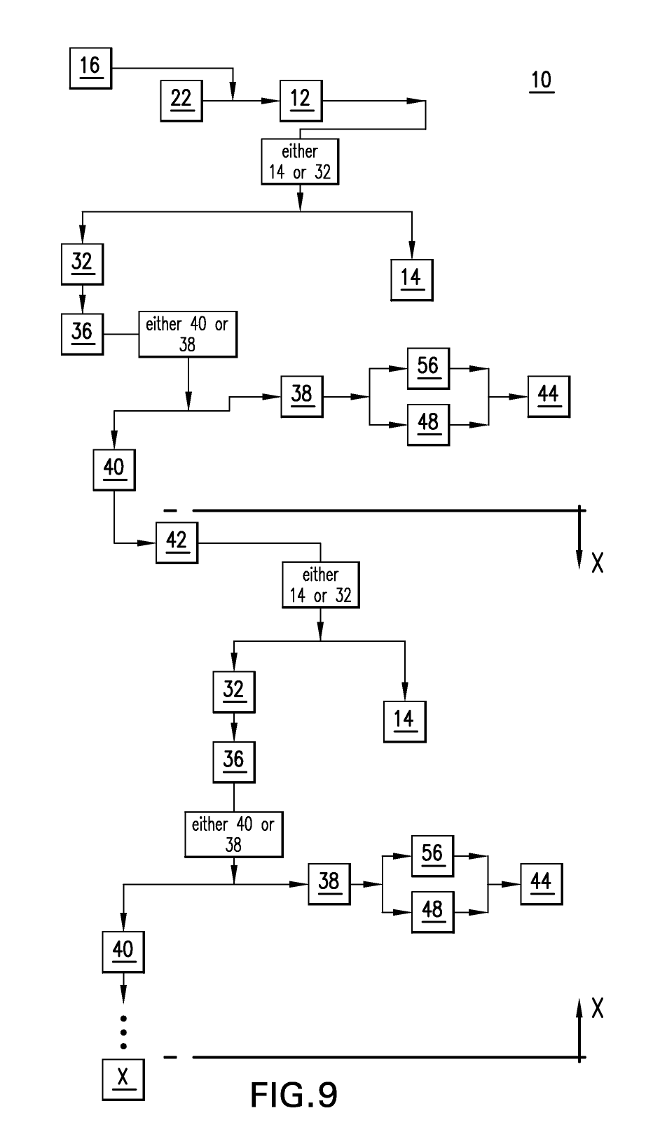

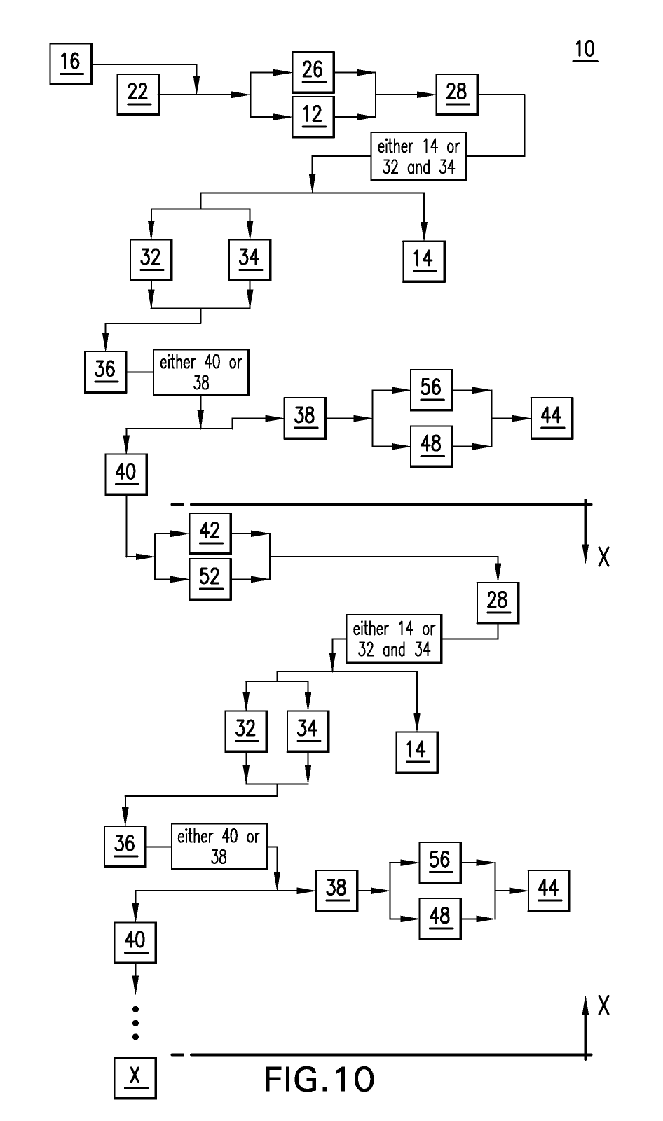

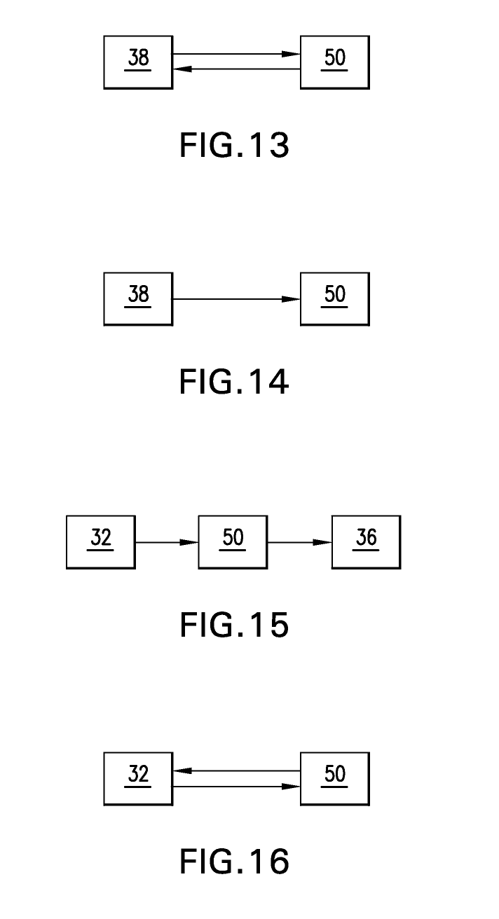

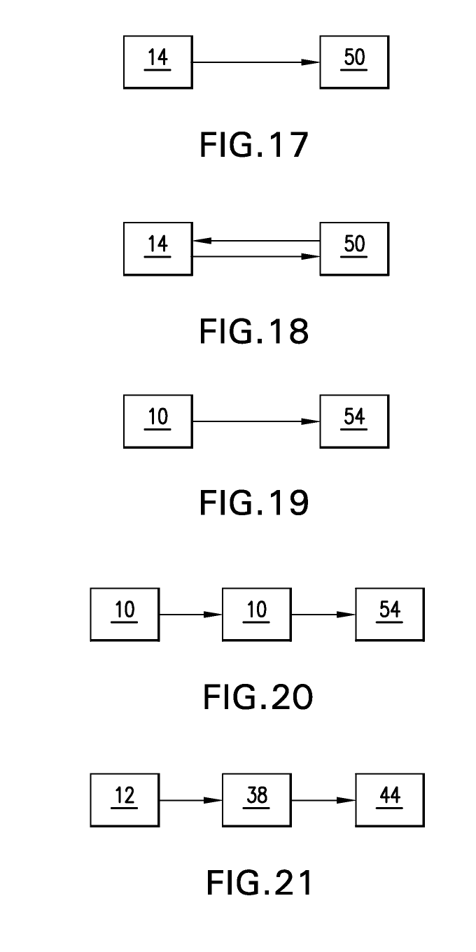

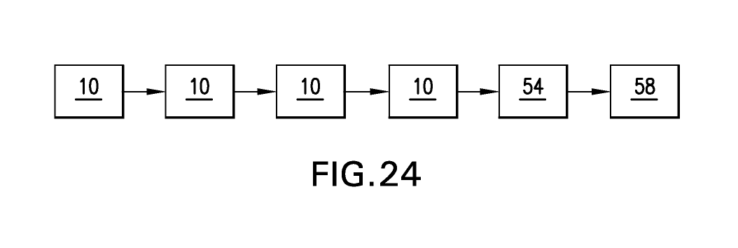

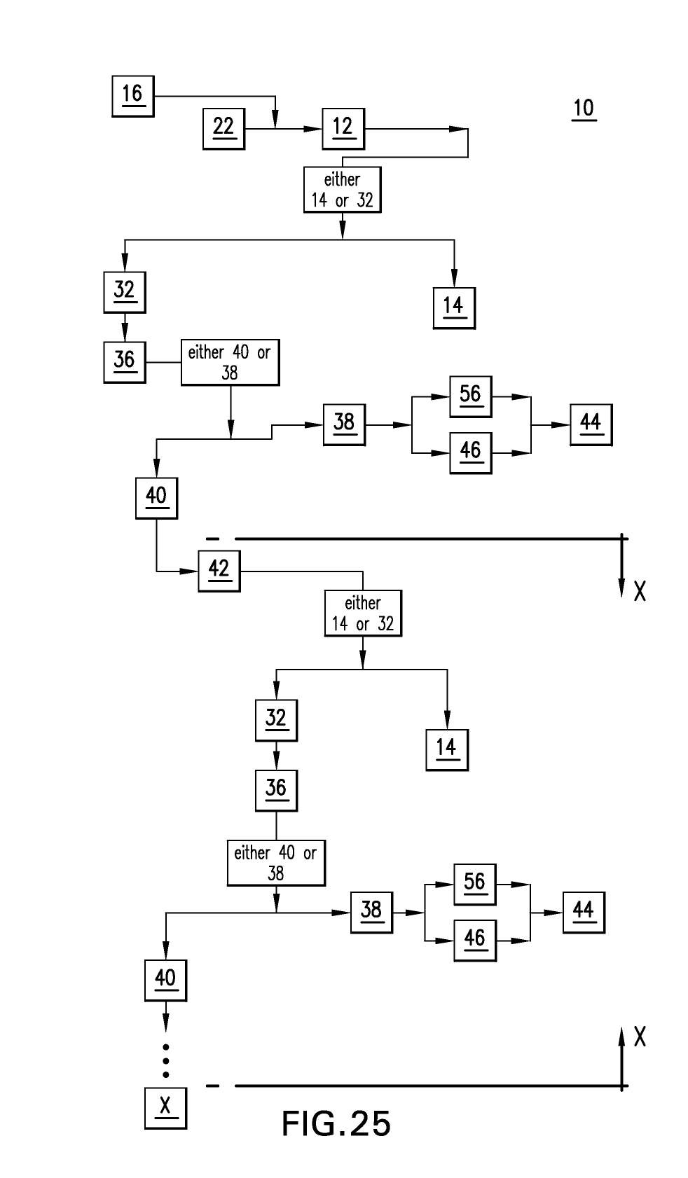

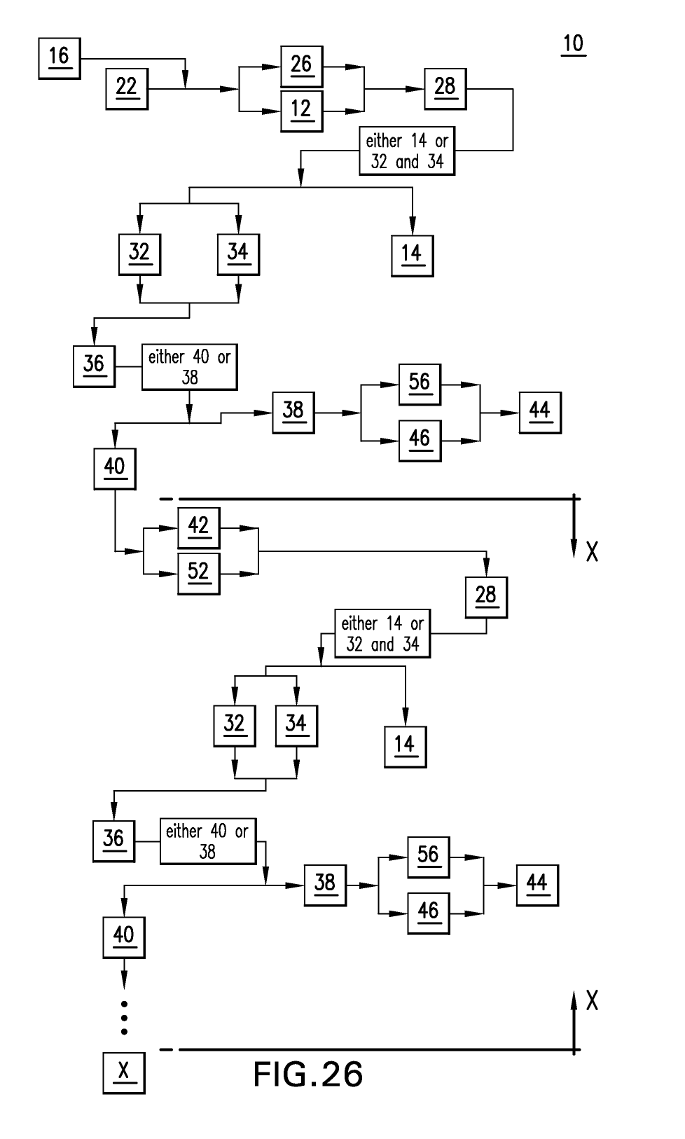

Reference is now made to FIGS. 1-28, wherein embodiments of the invention are exemplarily illustrated. Although the invention has been exemplarily illustrated by reference to specific embodiments, it will be apparent to those of ordinary skill in the art that various changes and modifications may be made which clearly fall within the scope of the invention. The invention is intended to be protected broadly within the spirit and scope of the appended claims.

Referring now to FIGS. 1-28, embodiments of the game and playing the game include playing 10 at least one segment round. Playing 10 each segment round includes providing 16 at least a segment 64 of at least one visual and/or audio advertisement. As known in the art, advertisements can be seen and/or heard on a variety of sources, including, television, radio, the internet, smart phone applications, and the like. However, as new technologies are discovered and developed and as new uses for known technologies are discovered, new sources for viewing and/or hearing visual and/or audio advertisements are being discovered each day. It is intended that the current invention will include known sources for visual and/or audio advertisements and those that will be discovered in the future.

As used herein the term “segment” 64 is used to identify at least one portion of an audio and/or visual advertisement or the entire visual and/or audio advertisement. For example, and without intending to be limiting, if an advertisement were 40 seconds in duration, a 30 second portion of the advertisement that does not include an identification of at least one thing being advertised could be made into the advertisement segment 64. Also for example, and without intending to be limiting, if an advertisement were 40 seconds in duration, a 10 second portion of the advertisement that does not include an identification of at least one thing being advertised could be made into the advertisement segment 64, and a different 10 second portion of the advertisement that does not include an identification of at least one thing being advertised could be made into the advertisement segment 64. Further, for example, and without intending to be limiting, if an advertisement were 40 seconds in duration, the entire commercial could be a segment 64, however, as explained in more detail below, the segment 64 would “end” 14 when the at least one thing being advertised is identified in the segment 64, such that if, for example, one thing being advertised were identified at 30 seconds, the segment would end 14 at 30 seconds.

It is further known in the art that visual and/or audio advertisements can be stored in are variety of media and technology, including, but not limited to, all types of videos, DVDs, video tapes, film strips, electrical technology, digital technology, analog technology, compact discs, flash drives, computers and the like. In addition reproductions and replicas of media and technology can be used to store visual and/or audio advertisements. However, as new technologies are discovered and developed and as new uses for known technologies are discovered, new media and technology for storing visual and/or audio advertisements are being discovered each day. It is intended that the current invention will include all known media and technology for storing visual and/or audio advertisements and those that will be discovered in the future.

It is further known in the art that visual and/or audio advertisements can be transmitted and presented 12 in a variety of media and technology, including, but not limited to all types of videos, DVDs, video tapes, film strips, electrical, digital, analog, compact discs, flash drives, computers and the like. In addition reproductions and replicas of media and technology can be used to transmit and present 12 visual and/or audio advertisements. However, as new technologies are discovered and developed and as new uses for known technologies are discovered, new media and technology for transmitting and presenting visual and/or audio advertisements are being discovered each day. It is intended that the current invention will include all known media and technology for transmitting and presenting visual and/or audio advertisements and those that will be discovered in the future. The term “presenting” as used herein includes enabling at least one person to watch visible media, hear audio media and/or watch and hear visual and audio media.

The advertisement can advertise anything, including but not limited to products and services.

The at least one segment 64 of a visual and/or audio advertisement will be presented 12 to all the players 60 simultaneously in a manner whereby each segment 64 at least does not immediately identify any of the advertised thing or things.

In some embodiments the at least one segment 64 will not identify the advertised thing or things. In some embodiments the number of seconds that the advertisement segment 64 will play before it ends without identifying the thing or things that are being advertised will be between two and five seconds. In some embodiments the number of seconds that the advertisement segment 64 will play before it ends without identifying the thing or things that are being advertised will be more than five seconds.

In some embodiments the at least one segment 64 will include at least one of the advertised thing or things. In some embodiments the number of seconds that the advertisement will play before at least one of the thing or things that are being advertised will be identified will be between two and five seconds. In some embodiments, at least one of the advertised thing or things will be identified in the segment after it has played for more than five seconds.

In some embodiments the at least one segment 64 will be presented 18 to a live audience 72. In some embodiments, the segment will be presented 20 to a remote viewing audience 74, such as but not limited to a television viewing audience. In some embodiments the advertisement segment 64 will be presented 12 by being displayed on at least one screen 62 that will be simultaneously visible to all the players, and if there is one, be visible to a live audience. In some embodiments when the game is transmitted and/or recorded, the advertisement segment 64 will be displayed on at least one screen 62 that will be visible to all the players simultaneously, if there is a live audience, to the live audience, and in addition at least one screen will be shown to the remote viewers of the game that are watching the transmission and/or recording. In some embodiments when the game is televised, the advertisement segment 64 will be displayed on at least one screen 62 that will be visible to all the players simultaneously, if there is a live audience, to the live audience, and in addition at least one screen will be shown to the television viewers of the game. In some embodiments, the advertisement segment will be simultaneously displayed to all the players and to a live audience. In some embodiments, the advertisement segment 64 will be simultaneously displayed to all the players and to an audience who is remotely watching a transmission of the game. In some embodiments, the advertisement segment will 64 be simultaneously displayed to all the players, a live audience and to an audience that is remotely watching a transmission of the game. In some embodiments, the advertisement segment will be simultaneously displayed to all the players, a live audience and to a television viewing audience that is watching a transmission of the game.

The method of the game includes providing 22 at least two players 60 for playing 10 each segment round. In some embodiments, three players 60 are provided for each segment round. In some embodiments, more than three players 60 are provided for each segment round. When the segment 64 is presented 12 to the players 60, the players simultaneously view and/or hear the segment 64 and compete against each other to be the first to identify at least one thing that is being advertised in the segment before the segment ends 14. As used herein, the terms “ending” the segment 14 segment “end” 14 segment “ends” 14 and the like mean either: 1) that a provided 16 advertisement segment 64 that does not identify at least one advertised thing has run for its full duration, or 2) that a provided 16 segment 64 that does include an identification of at least one advertised thing has run to the point where at least one thing being advertised is identified in the segment.

In some embodiments, at least one emcee 70 will also be provided 24. In some embodiments that are televised the method of the game will include providing 22 three players 60 and providing 24 one emcee 70 per game.

In some embodiments, when the at least one segment begins to play 16 a timer also is engaged 26 and the seconds are counted 28, referred to herein as a “passing second count” 28 until at least one player gives notice 32 or until the segment ends 14 either by coming to the end of the segment 64 provided or by the segment 64 identifying at least one thing being advertised.

In some embodiments, as the seconds pass during the passing second count 28, a passing second count value can calculated whereby some value is assigned to each second, fraction of a second or multiples of a second such that the value increases with each passing second, fraction of a second or multiples of a second. In some embodiments, as the seconds pass during the passing second count 28, points increase. By way of example, and not intending to be limiting, one point can be allocated for each second that passes during the presentation 12 of a segment before the segment ends 14 or a player gives notice 32 for a guess that correctly identifies 38 at least one item that is being advertised. In some embodiments, as the seconds pass during the passing second count 28, fixed money values for each second are added to one another. By way of example, and not intending to be limiting, one thousand dollars can be allocated for each second that passes during the presentation 12 of a segment 64 before the segment ends 14 or a player gives notice 32 for a guess that correctly 38 identifies at least one item that is being advertised. In some embodiments, an audio signal will also sound 30 with each passing second during the passing second count 28. Some embodiments will not utilize a timer.

The game includes enabling each player 60 to give notice 32 that that player 60 wants to try to identify at least one thing being advertised. The players can give notice 32 in any ways that will communicate that the player wants to try to identify at least one thing being advertised. In some embodiments, the manner of giving notice 32 will be the same for all the players. In some embodiments, the manner of giving notice will be identified to the players before the segment is played. Ways of giving notice 32 can include, but are not limited to: verbal communication, including but not limited to, verbalizing the product type and/or name, designating at least one word that the player must utter; physical communication, including but not limited to, banging a hand on a surface, waving a hand, stamping a foot, nodding one's head, and the like; mechanical communication, including but not limited to, giving the player a device that they must utilize to give notice, such as but not limited to banging a gavel, flipping a switch, hitting a button 78, turning a card, dropping an item, and the like. In some embodiments, each player will be given a signaling device 76 and which will provide an audible sound when a player actuates it.

In some embodiments, when a player, referred to as the “giving notice player”, gives notice 32, if there is a passing second count, the passing second count will stop 34. The giving notice player will be allowed to communicate 36 the giving notice player's guess of at least one thing that is being advertised. The communication 36 of a guess of at least one thing being advertised can be done in any way that provides communication, including but not limited to, verbal, sign language and written communication. If the giving notice player's communication 36 of the player's guess for the identification of at least one thing being advertised is incorrect 40, after the player makes the incorrect guess 40, the segment will continue playing 42 where it left off when the notice was given 32 and if there is a passing second count, after the player makes an incorrect guess 40 the passing second count will continue 52 where it left off when the notice was given. In some embodiments, during the playing 10 of a segment round, a player who previously was a giving notice player for that segment round but who did not correctly identify 40 at least one advertised thing for that segment may not give notice again during that segment round. In some embodiments, during the playing of a segment round 10, a player who previously was a giving notice player for that segment round but who did not correctly identify 40 at least one advertised thing for that segment round may give notice again during that segment round.

By way example, and not intending to be limiting, when a segment 64 begins running, $1,000.00 for will be the value for each passing second in the passing second count 28. If at three seconds a player gives notice, the segment will stop and the passing second count value will stop at $3,000.00. The player will be given an opportunity to make a guess 36. If the player makes an incorrect guess 40, afterward, the passing second count will begin again at $3,000.00 with the next passing second having a $4,000.00 value, and the segment will begin again where it left of and the segment will continue playing toward the end until another player gives notice 32 or the segment ends 14.

Referring now to FIGS. 1-4, 6-10, and 25-26 it will be noted that box “X” is intended to show that, depending on some factors that will be described in more detail below, the sequence, between the “X” arrows can be repeated various numbers of times.

By way or example, and not intending to be limiting, during the playing 10 of a segment round, if a player who previously was a giving notice player for that segment round who did not correctly identify 40 at least one advertised thing for that segment round and who may give notice again during that segment round, the X sequence can repeat itself as many times as necessary until the segment ends 14 or the giving notice player correctly identifies 38 at least one advertised thing. By way of further example, and without intending to be limiting, if a segment can run for 20 seconds before ending 14, and if players make numerous guesses in quick succession, the X sequence could repeat three or more times.

By way or further example, and not intending to be limiting, during the playing 10 of a segment round, if a player who previously was a giving notice player for that segment round who did not correctly identify 40 at least one advertised thing for that segment round and who may not give notice again during that segment round, the X sequence can repeat itself as many times as necessary until all the players who want to make one guess make a guess before the segment ends 14 or the giving notice player correctly identifies 38 at least one advertised thing. By way of further example, and without intending to be limiting, if the segment can run for 20 seconds before ending 14, and if there are six players, it would be possible for the X sequence to repeat three or more times.

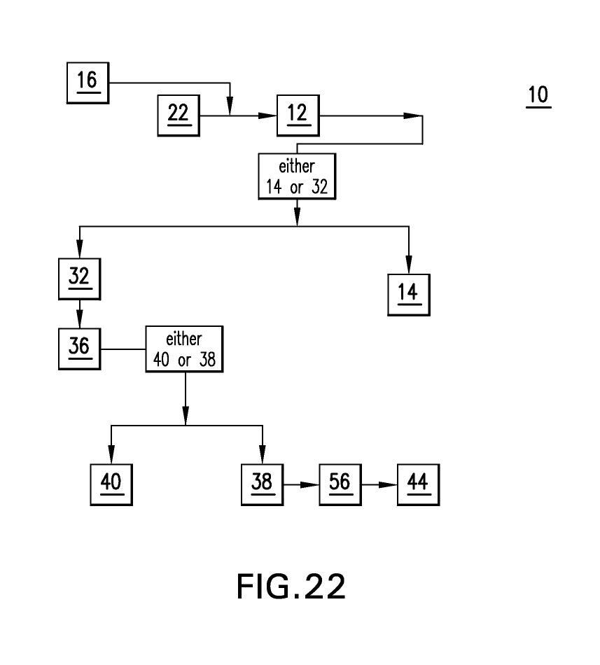

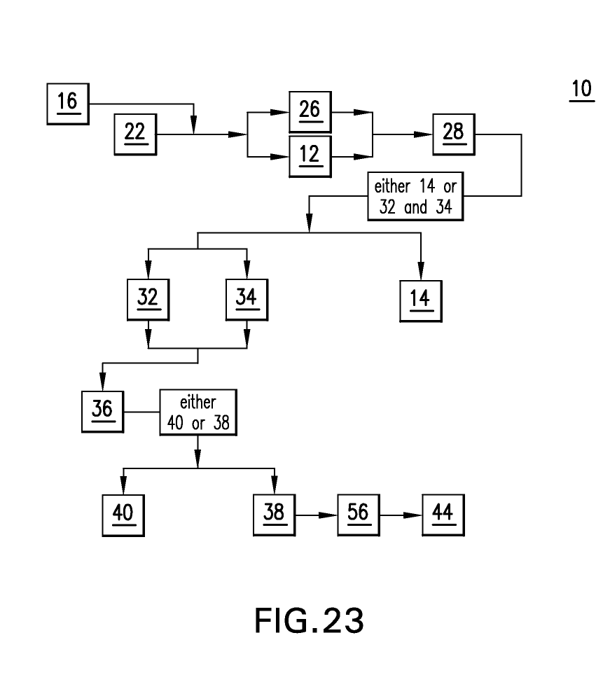

In addition in some embodiments, depending on some factors that will be described in more below, the “X” sequence will not occur at all, as exemplarily illustrated in FIGS. 22 and 23. By way of example and without intending to be limiting, if the segment can run for 3 seconds before ending 14, and if the first player to give notice gives notice 32 at 2.99 seconds, if the giving notice player gives an incorrect guess 40, there probably would not be enough time left for another player to give notice 32 before the segment ended.

In some embodiments, if the giving notice player 60 correctly guesses 38 at least one thing being advertised in the segment, at least one of the advertised things is displayed 46. The displaying 46 of at least one of the advertised things after the giving notice player correctly guesses 38 at least one advertised thing can be shown in ways including, but not limited to, displaying at least one advertised item on the advertisement viewing screen 62, the players screen 80, the remote viewing screen 86 and/or the passing second value display screen 88.

If the giving notice player 60 correctly guesses 38 at least one thing being advertised in the segment, the giving notice player will win 56 the segment round and be the segment winner. The segment winner will be rewarded 44 by ways including, but not limited to, by being given all the points accumulated from the passing second count for the segment round, by being given all the money accumulated in the passing second count for the segment round, by being given a cash value for the money accumulated in the passing second count for the segment round, by being given a cash value for the points accumulated in the passing second count for the segment round, declaring the segment winner the segment winner and/or by declaring the segment winner the game winner.

A game can be completely played 54 and the game winner identified by a number of ways, including, but not limited to by identifying the game winner as the player who has accumulated the highest dollar amount at a fixed time of play; identifying the game winner as the player who is the first to accumulate a predetermined dollar amount; identifying the game winner as the player who has accumulated the highest dollar amount after a predetermined number of segment rounds have been played, by identifying the game winner as the player who has accumulated the most points at a fixed time of play; identifying the game winner as the player who is the first to accumulate a predetermined number of points; identifying the game winner as the player who has accumulated the most number of points after a predetermined number of segment rounds have been played, by identifying the game winner as the player who has won most of the segment rounds at a fixed time of play; and/or identifying the game winner as the player who is the first to win a predetermined number of segment rounds. In some embodiments, as exemplarily illustrated in FIG. 19, playing 54 each game will consist of the playing 10 of only one segment round, and in such an embodiment, the segment winner will also be identified as the game winner. In some embodiments, the televised game will air in a thirty-minute time-slot, which, in some embodiments, will cause the actual playing time to be less than thirty minutes due to other activities that will be on air during the thirty-minute time slot.

The game winner can be rewarded 58 in a variety of ways in various embodiments, including, but not limited to receiving, cash and prizes. In some embodiments, the winning segment player will receive a cash value for the fixed money amount for the number of seconds that passed before the winning segment player won the segment round. In some embodiments at the end of the game, each player will receive cash in the amount of the cash value designated for each of the player's segment wins.

Some embodiments will include the following: each player 60 will have a screen 80 that can be a duel panel screen, which will display their score for each segment on one screen and their cumulative segment total score 82 on the other screen; with the passing seconds, the accumulated fixed money amount 84 for each second will be displayed and accumulate on each player's screen; when a player gives notice, the passing second count stops, and; when a player wins a segment round, all of the displays on the screens freeze and the winning segment player's screen begins to blink 48 on and off.

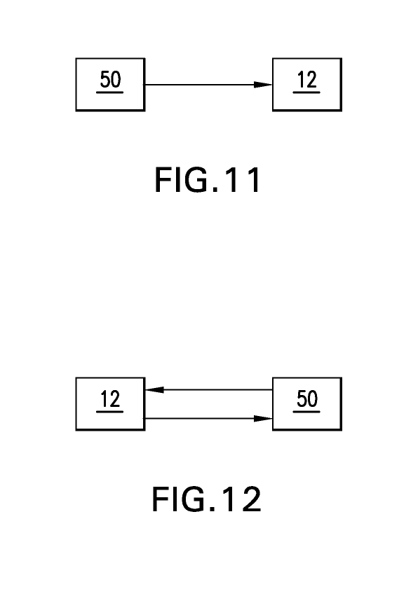

Referring now to exemplary FIGS. 11-18, some embodiments of the invention can include identifying 50 at least one segment round as a bonus round and providing at least one bonus during the game. Bonus rounds can be identified in a variety of ways including, but not limited to the list that follows. Some embodiments include identifying 50 a segment round as a bonus round before the segment begins playing. Some embodiments include identifying 50 a segment round as a bonus round during the playing of the segment. Some embodiments include identifying 50 a segment round as a bonus round when a player gives notice 32. Some embodiments include identifying 50 a segment round as a bonus round after a player gives notice 32 and before the giving notice player makes a guess 36 to identify at least one product or service being advertised. Some embodiments include identifying 50 a segment round as a bonus round when a player correctly identifies 38 at least one product or service being advertised. Some embodiments include identifying 50 a segment round as a bonus round when the segment ends 14. Some embodiments include identifying 50 a segment round as a bonus round after the segment ends 14. Some embodiments include identifying 50 a segment round as a bonus round after a player correctly identifies 38 at least one product or service being advertised. In some embodiments the determination of whether a segment round will include at least one bonus will be at the discretion of the producer of the game. The bonus can be any kind of reward, including, but not limited to, cash, at least one trip, at least one prize, additional points, enabling the winner of the bonus round to play another segment round without the competition of the other players, and the like.

One embodiment of the invention includes the following method: providing 22 three players, providing 18 an audience, providing 20 at home viewers, presenting 12 more than one video advertisement on at least one screen to three players, an audience, and at home viewers such that the video advertisement will be displayed to at least all the players simultaneously; fitting the game into a 30 minute time-slot; enabling the more than one advertisement segments to each be able to run for several seconds before ending; providing 24 an emcee 70; providing 30 an audible sound for each passing second; identifying a fixed money amount for each passing second; providing each player with a dual panel screen; displaying the accumulated money amount value for each passing second during the passing second count 28 for that segment round on one of each player's screens and displaying the each player's cumulative game total on their own other screen; providing each player with a signaling device that will provide an audible sound when it is actuated; enabling each player to give notice 32 by actuating their signaling device; simultaneously stopping 34 the passing second count when a player actuates their signaling device; freezing all displays when a player guesses 38 correctly to identify at least one thing being advertised; the blinking 48 on and off of a player's screen when a player makes a correct guess 38 to identify at least one thing being advertised; if the player makes an incorrect guess 40 to identify at least one thing being advertised, resuming 42 the presentation of the video advertisement segment where it left off, resuming 52 the passing second count where it left off, and resuming the money accumulation value pursuant to the passing second count where it left off; and awarding each player cash in the amounts that they have won.

The method can also include negotiating and executing at least one release for the use of the various advertisement segments. The negotiating and executing of at least one release can include contacting producers of the things advertised in the segments. In some embodiments, producers of the various advertisement segments could be asked to pay some costs for the usage of the at least one advertisement segment in the game.

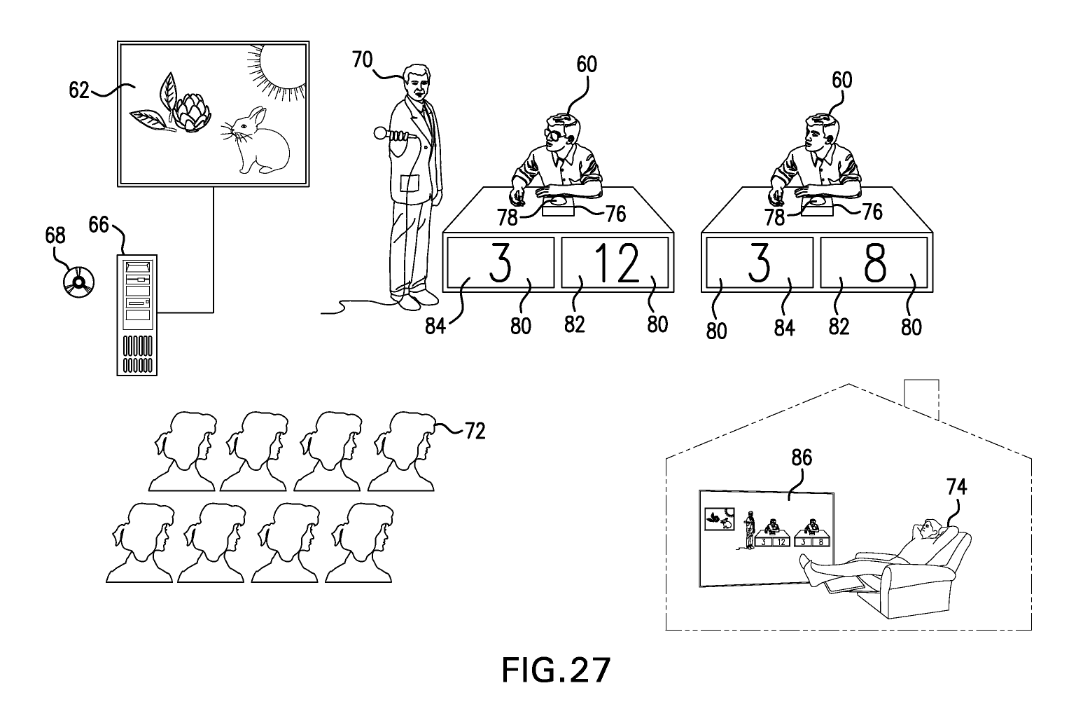

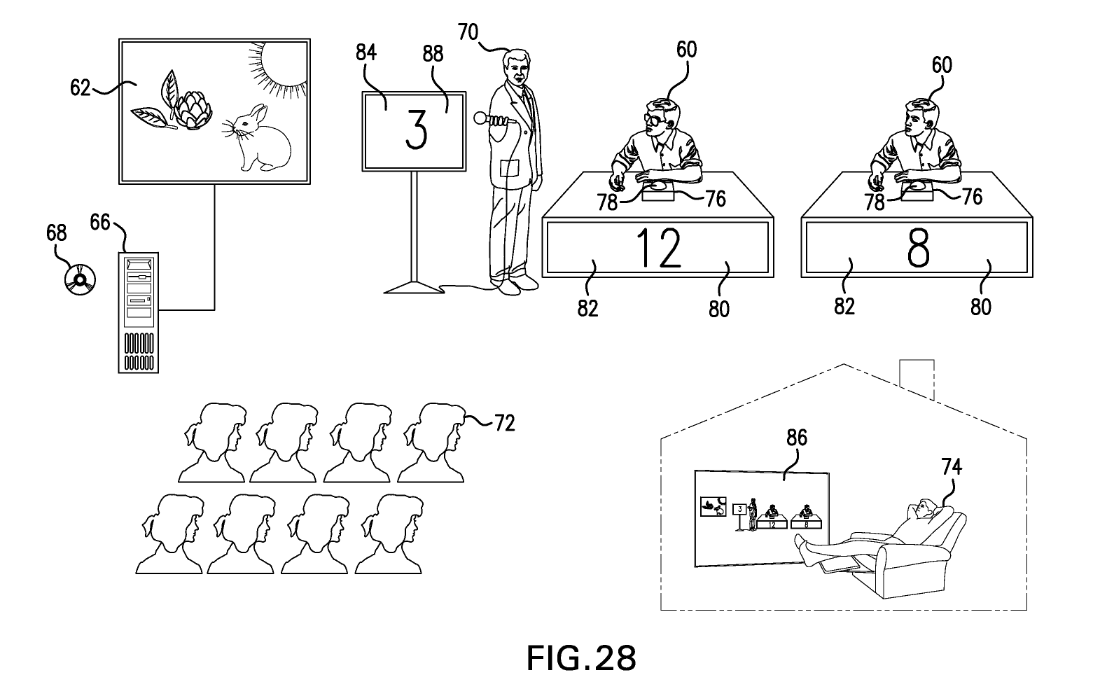

Reference is now made to FIGS. 27 and 28, which exemplarily illustrate embodiments of the game of the invention. The game includes more than one player 60. This illustration exemplarily illustrates two players, however it is to be noted that three players could be included, and other numbers of players, including more than three players, are intended to be included in embodiments of the invention. At least one advertisement viewing screen 62 is provided on which at all the players can see the playing of at least one advertisement segment 64 simultaneously. In this embodiment a computer 66 is included to play a DVD video 68 that contains the at least one segment 64 of at least one advertisement. As previously noted, however, other media and technologies for storing, transmitting and presenting at least one segment 64 of at least one advertisement are intended to be included in the invention, and the exemplary illustration of a computer and DVD video are not intended to be limiting. This embodiment of the invention further includes at least one emcee 70, a live audience 72 and a remote viewing audience 74. The remote viewer 74 is viewing the game on a remote-viewing screen 86, which in this embodiment is exemplarily illustrated as a home television screen, but it is intended that other technologies, currently known, such as but not limited to computers connected to the internet, smart phones and the like, and to be discovered are intended to be included for remote viewing of the game. This embodiment also includes at least one activation device 76, which in this embodiment is a device with a button 78 that makes a sound when the button 78 is pressed and also simultaneously stops the passing second count. It is intended that all devices currently known in the art or to be discovered, and other ways of giving notice, are intended to be included to enable a player to give notice. This embodiment exemplarily includes one activation device 76 for each player. This embodiment further exemplarily illustrates at least one player screen 80 for each player that at least displays the cumulative score 82 of each player. In addition, as exemplarily illustrated in FIG. 27, each player can have more than one screen. FIG. 27 exemplarily illustrates each player 60 having two screens; one that displays the cumulative score 82 and one that displays the passing second count value 84, which can be shown in a variety of ways including but not limited to, money units, such as but not limited to cents or dollars, points, seconds and the like. In some embodiments, as exemplarily illustrated in FIG. 28, the passing second value display 84 can be displayed on a passing second value display screen 88 that is not a player screen 80.

1. A method for playing a televised game, said method comprising providing three contestants, displaying a product advertisement segment simultaneously to each of said contestants, and awarding a dollar amount to the contestant who is the first contestant to correctly identify the product being advertised in the advertisement segment.

2. A method for playing a game, said game comprising providing more than one player; said game further comprising providing at least one segment of an advertisement simultaneously to each of said more than one players, said advertisement advertising at least one advertised thing, said segment at least not immediately identifying any of the at least one advertised things, said game further comprising identifying the winning segment player for each segment as the player who is the first player to identify at least one of the advertised things in said advertisement without seeing or hearing in said segment any of the at least one advertised things, and rewarding said winning segment player.

3. The method of claim 2, said method further comprising televising said game.

4. The method of claim 2, wherein said advertisement segment is in video.

5. The method of claim 2, said method further comprising providing said advertisement in at least one electronic transmission.

6. The method of claim 2, said method further comprising allocating a fixed dollar amount for each second that said segment plays.

7. The method of claim 6, said method further comprising adding said fixed dollar amount to each second that passes before a player gives notice.

8. The method of claim 7, said method further comprising rewarding said winning segment player with the cash value of the fixed dollar amount that had accumulated at the time that said winning segment player gave notice.

9. The method of claim 8, said method further comprising identifying the game winner as the player who has accumulated the highest dollar amount at a fixed time of play.

10. The method of claim 7, said method further comprising, after a game has ended, giving each player cash in the amount of each player's own fixed dollar amount accumulation.

11. The method of claim 2, said rewarding further comprising awarding points.

12. The method of claim 2, said method further comprising providing a bonus to the segment winner.

13. The method of claim 12, said method further comprising identifying at least one segment as a bonus segment before the segment begins playing.

14. The method of claim 2, said method further comprising enabling each said player to give notice when said player wants to try to identify an advertised product or service.

15. The method of claim 14, said method further comprising stopping said segment when a player gives notice.

16. The method of claim 15, said method further comprising allowing the player who gives notice to guess at least one product or service being identified in said segment.

17. The method of claim 16, said method further comprising continuing the playing of the segment if the player who gives notice does not guess at least one correct product or service being advertised.

18. The method of claim 17, said method further comprising enabling the at least one player who has not already given notice for the segment to give notice when said player wants to try to identify an advertised product or service.

19. A game, said game comprising at least one segment of a moving commercial, said segment being at least stoppable and re-startable, at least one audio and/or visual player to provide said at least one moving commercial segment, and at least one timer.

20. The game of claim 19 wherein said at least one audio and/or visual player further comprises at least one television.

21. The game of claim 19 wherein said at least one audio and/or visual player further comprises at least one iPod.

22. The game of claim 19 wherein said at least audio and/or visual player further comprises at least one memory card or flash drive.
